(19) United States
(12) Patent Application Publication
(10) Pub. No.: US 2022/0044151 A1
(43) Pub. Date: Feb. 10, 2022

(54) APPARATUS AND METHOD FOR ELECTRONIC DETERMINATION OF SYSTEM DATA INTEGRITY

(71) Applicant: FRONT END ANALYTICS LLC, Boston, MA (US)

(72) Inventors: Daniel Augusto BETTS, Parkland, FL (US); Juan Fernando BETTS, Parkland, FL (US); Sreekanth GONDIPALLE, Katy, TX (US)

(73) Assignee: FRONT END ANALYTICS LLC, Boston, MA (US)

(21) Appl. No.: 17/395,972

(22) Filed: Aug. 6, 2021

Related U.S. Application Data
(60) Provisional application No. 63/061,867, filed on Aug. 6, 2020.

(51) Int. Cl. G06N 20/00; G06F 16/23

(52) U.S. Cl. CPC G06N 20/00; G06F 16/2379

(57) ABSTRACT

This application relates to apparatus and methods for determining the integrity of data, such as sensor data, in systems. In some examples, a computing device receives input data for the system, and executes a physics-based model to generate a first output. The physics-based model may include a plurality of surrogate models that simulate various portions of the system. The computing device may further execute a machine learning model that operates on the first output to generate a second output. The computing device may generate a predicted output for the system based on the first output and the second output. In some examples, the computing device determines an error for the system based on the predicted output and sensor data received from sensors for the system. Based on the error, the computing device determines if the sensor data is valid. The computing device may then provide an indication of the determination.

### CROSS-REFERENCE TO RELATED APPLICATIONS

This application claims priority to U.S. Provisional Patent Application No. 63/061,867, filed on Aug. 6, 2020 and entitled “APPARATUS AND METHOD FOR ELECTRONIC DETERMINATION OF SYSTEM DATA INTEGRITY,” which is hereby incorporated by reference in its entirety.

### FIELD OF THE INVENTION

The disclosure relates generally to determining data integrity in systems, such as multi-component systems, and, more specifically, to apparatus and processes for classifying the system data.

### BACKGROUND

In the field of data collection and analysis, a major question for engineers is whether the data collected from a sensor (e.g., sensor data) is an accurate representation of what the sensor is trying to measure. Sensor data may be erroneous due to a variety of reasons. For example, errors in sensor data may be caused by a loss of sensor calibration, which in some examples creates an off-set value that is different to the true value of what the sensor is measuring. In some examples, excessive noise (e.g., environmental noise) causes error in sensor data, thereby obfuscating the true value of the measurement. In some examples, sensors experience a loss of signal, which may result in a decrease or increase in a measurement value compared to an accurate measurement. In other examples, sensor data may contain errors due to bad (e.g., incorrect) sensor placement. As a result, the sensor may no longer be measuring the intended signal or other physical effect. Other causes of errors in sensor data may also exist.

The fidelity of sensor data is critical in many processes and devices. For example, control systems depend on sensor accuracy to make machines or systems operate as expected. In product development, machine tests may rely on sensor accuracy to analyze performance, to validate models (e.g., model validation), and to predict future machine performance. Because of these and many other reasons, the accuracy of sensor data is critical.

### SUMMARY

Disclosed herein are embodiments of a device and its corresponding methods that classify data from one or more sensors as, for example, reliable or unreliable. The device may use a machine learning model to train established weight vectors based on sensor data. Once the machine learning model is trained, the device is able to classify new sensor data as reliable or unreliable. In some examples, if the device determines sensor data to be unreliable, the device may provide a reason as to why the sensor data is deemed to be unreliable.

For example, in some embodiments, a computing device is configured to receive sensor data from at least one sensor for a system. The computing device is also configured to determine a first value based on execution of a first model that operates on the sensor data and characterizes a relationship between inputs to the system and outputs from the system. Further, the computing device is configured to determine a second value based on execution of a second model that operates on the first value. The computing device is also configured to determine a sensor prediction value for the at least one sensor based on the first value and the second value. The computing device is further configured to determine whether the sensor data is valid based on the sensor prediction value.

In some embodiments, a method by a computing device includes receiving sensor data from at least one sensor for a system. The method also includes determining a first value based on execution of a first model that operates on the sensor data and characterizes a relationship between inputs to the system and outputs from the system. Further, the method includes determining a second value based on execution of a second model that operates on the first value. The method also includes determining a sensor prediction value for the at least one sensor based on the first value and the second value. The method further includes determining whether the sensor data is valid based on the sensor prediction value.

In some embodiments, a non-transitory computer readable medium has instructions stored thereon, where the instructions, when executed by at least one processor, cause a computing device to perform operations that include receiving sensor data from at least one sensor for a system. The operations also include determining a first value based on execution of a first model that operates on the sensor data and characterizes a relationship between inputs to the system and outputs from the system. Further, the operations include determining a second value based on execution of a second model that operates on the first value. The operations also include determining a sensor prediction value for the at least one sensor based on the first value and the second value. The operations further include determining whether the sensor data is valid based on the sensor prediction value.

In some embodiments, a computing device is configured to receive sensor data from at least one sensor for a system. The computing device is also configured to determine a first value based on execution of a physics-based model that operates on the sensor data and is based on at least one mathematical relationship between inputs to the system and outputs from the system. Further, the computing device is configured to determine a second value based on execution of a machine learning model that operates on the first value. The computing device is also configured to determine a sensor prediction value for the at least one sensor based on the first value and the second value. The computing device is further configured to determine whether the sensor data is valid based on the sensor prediction value.

In some embodiments, a method by a computing device includes receiving sensor data from at least one sensor for a system. The method also includes determining a first value based on execution of a physics-based model that operates on the sensor data and is based on at least one mathematical relationship between inputs to the system and outputs from the system. Further, the method includes determining a second value based on execution of a machine learning model that operates on the first value. The method also includes determining a sensor prediction value for the at least one sensor based on the first value and the second value. The method further includes determining whether the sensor data is valid based on the sensor prediction value.

In some embodiments, a non-transitory computer readable medium has instructions stored thereon, where the instructions, when executed by at least one processor, cause a computing device to perform operations that include receiving sensor data from at least one sensor for a system. The operations also include determining a first value based on execution of a physics-based model that operates on the sensor data and is based on at least one mathematical relationship between inputs to the system and outputs from the system. Further, the operations include determining a second value based on execution of a machine learning model that operates on the first value. The operations also include determining a sensor prediction value for the at least one sensor based on the first value and the second value. The operations further include determining whether the sensor data is valid based on the sensor prediction value.

In some embodiments, a computing device is configured to receive sensor data from a plurality of sensors for a system. The computing device is also configured to determine an output value based on executing each of a plurality of classifiers, where each classifier is trained based an operating regime of the system, and where each output value indicates a likelihood that the system is operating under the corresponding operating regime. Further, the computing device is configured to provide the output values to a final classifier. The computing device is also configured to determine a prediction value based on executing the final classifier, where the prediction value indicates the operating regime of the system.

In some embodiments, a method by a computing device includes receiving sensor data from a plurality of sensors for a system. The method also includes determining an output value based on executing each of a plurality of classifiers, where each classifier is trained based an operating regime of the system, and where each output value indicates a likelihood that the system is operating under the corresponding operating regime. Further, the method incudes providing the output values to a final classifier. The method also includes determining a prediction value based on executing the final classifier, where the prediction value indicates the operating regime of the system.

In some embodiments, a non-transitory computer readable medium has instructions stored thereon, where the instructions, when executed by at least one processor, cause a computing device to perform operations that include determining an output value based on executing each of a plurality of classifiers, where each classifier is trained based an operating regime of the system, and where each output value indicates a likelihood that the system is operating under the corresponding operating regime. Further, the operations include providing the output values to a final classifier. The operations also include determining a prediction value based on executing the final classifier, where the prediction value indicates the operating regime of the system.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a system data classification system in accordance with some embodiments;

FIG. 2 is a block diagram of the system data classification computing device of the system data classification system of FIG. 1 in accordance with some embodiments;

FIGS. 3A and 3B illustrate a system data classifier that may be employed by the system data classification computing device of FIG. 2 in accordance with some embodiments;

FIG. 4 illustrates an exemplary physics-based model and an exemplary machine learning corrective model that may be employed by the system data classification computing device of FIG. 2 in accordance with some embodiments;

FIG. 5 illustrates another exemplary physics-based model and another exemplary machine learning corrective model that may be employed by the system data classification computing device of FIG. 2 in accordance with some embodiments

FIG. 6 illustrates an oil temperature prediction engine that may be employed by the system data classification computing device of FIG. 2 to classify oil temperatures in accordance with some embodiments;

FIG. 7 illustrates a multi-level classification scheme that may be employed by the system data classification computing device of FIG. 2 in accordance with some embodiments;

FIGS. 8A and 8B graphically illustrate the classification of data as may be determined by the system data classification computing device of FIG. 2 in accordance with some embodiments;

FIG. 9 is a flowchart of an example method that can be carried out by the system data classification system of FIG. 1 in accordance with some embodiments; and

FIG. 10 is a flowchart of another example method that can be carried out by the system data classification system 100 of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

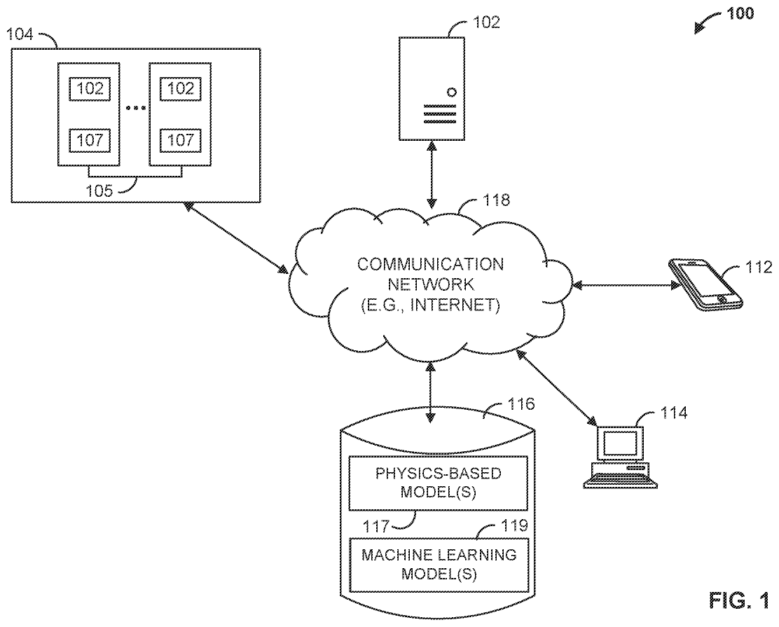

Turning to the drawings, FIG. 1 illustrates a block diagram of a system data classification system 100 that includes a system data classification computing device 102, a system 104, database 116, and multiple customer computing devices 112, 114 communicatively coupled over communication network 118.

As discussed herein, in some examples, system data classification computing device 102 can receive sensor data from at least one sensor for a system. System data classification computing device 102 can also determine a first value based on execution of a first model that operates on the sensor data and characterizes a relationship between inputs to the system and outputs from the system. System data classification computing device 102 can further determine a second value based on execution of a second model that operates on the first value. System data classification computing device 102 can also determine a sensor prediction value for the at least one sensor based on the first value and the second value. System data classification computing device 102 can further determine whether the sensor data is valid based on the sensor prediction value.

In some examples, the first model is a physics-based model that operates on the sensor data and is based on at least one mathematical relationship between inputs to the system and outputs from the system, and the second model is a machine learning model that operates on the first value.

In some examples, the at least one sensor comprises a first sensor and a second sensor, the first model is a first classifier that operates on first sensor data from the first sensor, and the second model is a final classifier. Further, system data classification computing device 102 can determine a third value based on execution of a second classifier that operates on second sensor data from the second sensor, and determine the second value based on execution of the final classifier that operates on the first value and the third value.

Communication network 118 can be a WiFi network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

System data classification computing device 102 and multiple customer computing devices 112, 114 can each be any suitable computing device that includes any hardware or hardware and software combination for processing data. For example, each of system data classification computing device 102 and multiple customer computing devices 112, 114 can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

System data classification computing device 102 can be, for example, a computer, a workstation, a laptop, a server such as a cloud-based server or an application server, or any other suitable computing device.

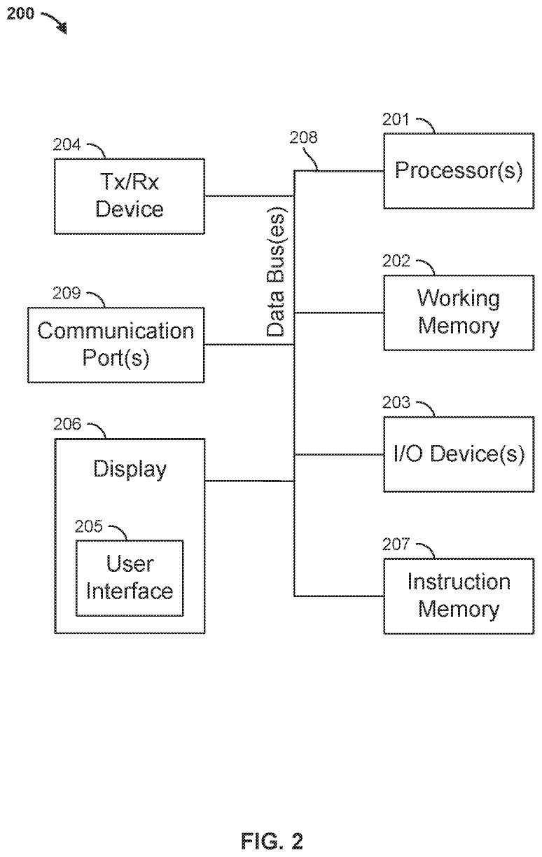

FIG. 2 illustrates an example of a system data classification computing device 102. System data classification computing device 102 includes one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory, an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of system data classification computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 207 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 207 allow for the transfer (e.g., uploading or downloading) of data, such as data identifying and characterizing a physics-based model or a machine learning model.

Display 206 can display user interface 205. User interfaces 205 can enable user interaction with system data classification computing device 102. For example, user interface 205 can be a user interface for an application (“App”) that allows a user to configure a physics model or machine learning model implemented by system data classification computing device 102. In some examples, a user can interact with user interface 205 by engaging input-output devices 203. In some examples, display 206 can be a touchscreen, where user interface 205 is displayed on the touchscreen.

Transceiver 204 allows for communication with a network, such as communication network 118 of FIG. 1. For example, if communication network 118 is a cellular network, transceiver 204 is configured to allow communications with the cellular network. Processor(s) 201 is operable to receive data from, or send data to, a network, such as communication network 118, via transceiver 204.

Referring back to FIG. 1, each of multiple customer computing devices 112, 114 can be a laptop, a computer, a mobile device such as a cellular phone, a smart phone, a tablet, a personal assistant device, a voice assistant device, a digital assistant, or any other suitable device. Although FIG. 1 illustrates two customer computing devices 112, 114, system data classification system 100 can include any number of customer computing devices 112, 114. Similarly, system data classification system 100 can include any number of system data classification computing devices 102, systems 104, and databases 116.

System 104 can be any system that takes in one or more inputs, and produces one or more outputs. Inputs and outputs may include, for example, data (e.g., signal data, control data, sensor data, specification data), material, fuel, or any other input. System 104 can include any number of subsystems 105 that are operatively or communicatively coupled to each other. For example, a first subsystem 105 of system 104 may receive one or more system inputs, and provide one or more subsystem outputs. A second subsystem 105 of system 104 may receive one or more of the outputs of the first subsystem 105, and provide one or more subsystem outputs. Similarly, system 104 may include additional subsystems. System 104 may provide one or more outputs, such as one or more outputs of any subsystem 105.

System 104 may further include one or more sensors 107. For example, each subsystem 105 of system 104 may include one or more sensors 107. Sensors 101 may measure or detect a physical phenomenon of system 104, such as of a subsystem 105. For example, a sensor 101 may detect temperature, speed, time, light, pressure, rates (e.g., acceleration rates, rotational rates), sound, altitude, fuel, gas (e.g., smoke) or any type of physical phenomenon capable of being detected or measured. For example, sensor 107 can be any type of sensor.

Each sensor 107 may generate a signal (e.g., data) that indicates a detection, or measurement, of the corresponding physical phenomenon. System data classification computing device 102 is operable to receive the signals from sensors 107. In some cases, the signals may be biased or corrupted for one or more reasons such as, for example, measurement errors, transmission errors, signal noise, sensor placement variation (e.g., sensor placement error), “wear and tear,” or other exogenous effects that may affect the quality of the sensor's measurement or signal (e.g., errors due to the sensor's environment, such as heat).

System data classification computing device 102 is operable to communicate with database 116 over communication network 118. For example, system data classification computing device 102 can store data to, and read data from, database 116.

Database 116 can be a remote storage device, such as a cloud-based server, a memory device on another application server, a networked computer, or any other suitable remote storage. Although shown remote to system data classification computing device 102, in some examples, database 116 can be a local storage device, such as a hard drive, a non-volatile memory, or a USB stick.

In this example, database 116 may store data identifying and characterizing one or more physics-based models 117 and one or more machine learning models 119. System data classification computing device 102 may obtain, and execute, one or more of physics-based models 117. Similarly, System data classification computing device 102 may obtain, and execute, one or more of machine learning models 119.

Physics-based models 117 may identify and characterize one or more models (e.g., algorithms), such as system or system component simulation models. For example, a physics-based model 117 may include one or more reduced order models (ROMs). In some examples, a physics-based model 117 includes a multi-stage ROM that simulates a system, or one or more components of a system.

In some examples, a physics-based model 117 includes one or more surrogate models (SMs). Each SM may include an architecture that uses physics or mathematically informed approaches (simplified physics, finite element analysis, chemical processes, etc.) and data-driven statistical approaches (regression, multivariate statistics, Bayesian approaches, Uncertainty Quantification (UQ) methods, etc.) in a multi-stage structure. The SMs can be trained, improved, and validated to optimize predictive capabilities. As a result, computational times required to develop SMs are reduced, and their predictive capabilities are increased. Additionally, the use of physical or mathematically informed approaches in each SM reduces the amount of data required to train the respective SM to achieve the higher predictive accuracies.

For example, an SM may predict the output (0) of a system to received inputs (\tilde{x}). Each output can be, for example, a quantification of the present, past, or future states of the systems. For example, an SM may be generated to predict the remaining useful life of a component in an engine. In this example, the SM may predict present machine states and future machine states of the engine. The output of the SM (O_{SM}) may be a prediction of output O. An error (E) (e.g., a system error) may be defined as O-O_{SM}, in other words, the difference between an actual output O of a system and the predicted output of the system O_{SM}.

Machine learning models 119 may identify and characterize one or more machine learning models that can classify data using machine learning processes or techniques. For example, machine learning models 119 may include a machine learning classifier based on Naïve Bayes, Decision Trees, Logistic Regression, K-Nearest Neighbor, Deep Learning, or Support Vector Machines.

In some examples SMs can be used to evaluate the quality of data received from sensors 107 in a machine. Sensor data that relates to machine performance or state, and sensors 107 that provide data on processes or features that affect machine performance or state, may be employed during machine testing and evaluation. The accuracy of these sensors can be affected by multiple factors during machine testing. These factors could include voltage fluctuations, temperature excursions, humidity, vibration, shock, bad placement, and damage, among other things. Given the expense of tests, it is useful to have real time evaluation of the quality of the data provided by sensors. For this one or more SMs may be employed. An SM can predict a machine's performance and/or state based on data received from the sensors 107. If the SM prediction varies substantially from the machine's actual performance, this may indicate sensor 107 error.

In some examples, the SM can be trained to relate bounds of probable or acceptable sensor readings based on the data of multiple sensors in a machine. If the relationships between machine sensor data from the multiple sensors is outside one or more statistically probable relationships, this may indicate a high likelihood that a sensor error exists.

An alternative application is the use of the SM to adapt machine controls to the loss of a sensor. In this example, the SM can predict a most likely output of a damaged sensor and use this prediction as an input to the machine's control system. Through this method, the life of a machine can be extended. This may be particularly important for machines that are difficult to service or that must maintain operation even when certain sensors are no longer operational.

As described further below, system data classification computing device 102 may obtain sensor data from one or more sensors 107 from system 104, and determine the integrity of the sensor data. For example, system data classification computing device 102 may receive sensor data from one or more sensors 107 from one or more subsystems 105 of system 104, and predict one or more outputs (e.g., output value, range of output values) of system 104 (or one or more outputs of the one or more subsystems 105 of system 104) based on execution of a physics-based model 117 that operates on the sensor data. System data classification computing device 102 may then execute a machine learning model 119 based on the predicted output of the physics-based model 117 and, in some examples, at least a portion of the sensor data. Execution of the machine learning model 119 may generate classification data identifying a classification of the sensor data. In some examples, based on the classified data, the sensor data may be determined to be “valid” sensor data (e.g., “good” sensor data), or “bad” sensor data. “Valid” sensor data may be sensor data that can be relied on (e.g., the sensor is producing valid sensor data). “Bad” sensor data may be sensor data that should not be relied on. For example, “bad” sensor data may be corrupted.

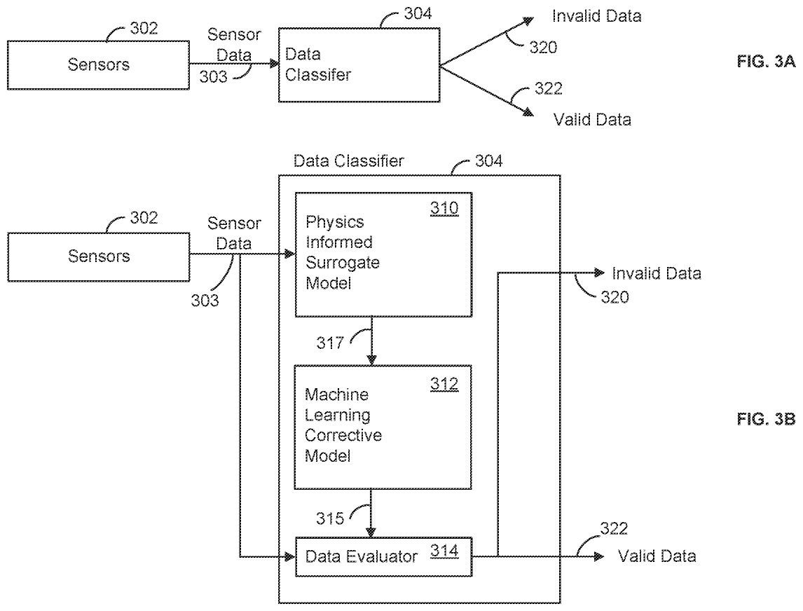

For example, FIG. 3A illustrates a data classifier 304 receiving sensor data 303 from one or more sensors 302. Data classifier 304 (which may include a physics-based model 117 and/or a machine learning model 119) may determine whether sensor data 303 is invalid data 320, or valid data 322.

FIG. 3B illustrates a more detailed block diagram of data classifier 304. As illustrated, data classifier 304 includes a physics-based model 117 that, in this example, is a physics informed surrogate model 310, a machine learning model 119 that, in this example, is a machine learning corrective model 312, and a data evaluator engine 314. Each of physics informed surrogate model 310 and machine learning corrective model 312 may be implemented by, for example, processor(s) 201 obtaining and executing instructions from instruction memory 207. For example, system data classification computing device 102 may obtain a physics-based model 117 and a machine learning model 119 from database 116, parse each of physics-based model 117 to obtain executable instructions for each model, and store the executable instructions for each model in instruction memory 207. Processor(s) 201 may then obtain the executable code from instruction memory 207, and execute the models.

In some examples, physics informed surrogate model 310 can generate physics-based model data 317 identifying a most likely sensor 107 output given certain system inputs. The system inputs may include data indicating the operation of the system 104 or sensor data 303 received from other sensors 302. In some cases, the sensor input data may could include a time-series record of prior sensor data 303 such as, for example, sensor data 303 received from one or more sensors 302 every second for the last minute. Physics-based model data 317 may be provided to machine learning corrective model 312 for classification. Specifically, based on physics-based model data 317 and/or sensor data 303 for one or more sensors (e.g. the same sensors 107 providing data to physics informed surrogate model 310 or, in some examples, additional sensors 107), the machine learning corrective model 312 generates a prediction value 315 that may be mathematically represented as yₚ, for example. The prediction value yₚ 315 may be based, for example, on the following formula:

y_{P}=f[P(x̅,w̅ₚ̅),M(x̅,w̅ₘ̅)] (eq. 1)
where:
   \tilde{x} is the input vector to the filter device;
   P is the physics function;
   M is the machine learning function; and
   w̅ₚ̅ and w̅ₘ̅ are coefficients.

The actual form of P and of M can be determined through evaluation of the physical phenomena that governs a desired sensor's 302 signal as well as through training of multiplying coefficients (e.g., weights) (w̅ₚ̅ and w̅ₘ̅). The training of the coefficients may be based on the minimization of an error function E (e.g., by executing a minimization function) that identifies the relative or actual difference between the prediction value yₚ and an actual value from a sensor 302 (e.g., y). The error function E may be based on the squared difference between yₚ and y; the mean square error; the absolute value of the difference between yₚ and y; or any other error functions known in the art.

In some examples, the physics function, P, is composed of multiple coupled physics informed functions that govern the physical phenomenon being measured by one or more sensors 302. Examples include physics functions P based on conservation of mass principles (e.g., mathematical relationships), conservation of energy principles, conservation of momentum principles, kinematic principles, stress-strain relationships, mechanical limits principles, established empirical correlations, electrical conduction principles, heat transfer principles, or any other principle that may be applied in the fields of engineering and/or applied sciences.

Data evaluator engine 314 receives prediction value yₚ 315 from the machine learning corrective model 312, as well as sensor data 303 from sensors 302. Data evaluator engine 314 may compare the prediction value yₚ 315 to the sensor data 303 to generate an error value. The error value may be determined, for example, based on the error function E described above. In some examples, if the error value is within a confidence interval (e.g., a range of values), data evaluator engine 314 classifies the sensor data 303 as valid data 322 (e.g., good data). Otherwise, if the error value is not within the confidence interval, data evaluator engine 314 classifies the sensor data 303 as invalid data 320 (e.g., bad data). In some examples, valid data 322 and invalid data 320 are binary values (e.g., “0” for invalid sensor data, “1” for valid sensor data).

In some examples, data classifier 304 is trained by modifying the weights of a physics function (e.g., physics informed surrogate model 310) and of a machine learning function (e.g., machine learning corrective model 312) such that the error between sample sensor data (e.g., training data), (which may be statistically representative of the population of sensor data that data evaluator engine 314 will be made to classify once implemented), and prediction data (e.g., prediction value yₚ) is minimized. The minimization may be computed according to any commonly known optimization technique. In addition, a statistical confidence interval for the error can be established using statistical techniques known in the art. The statistical confidence interval may indicate a confidence (e.g., a probability) that a particular prediction value yₚ is valid.

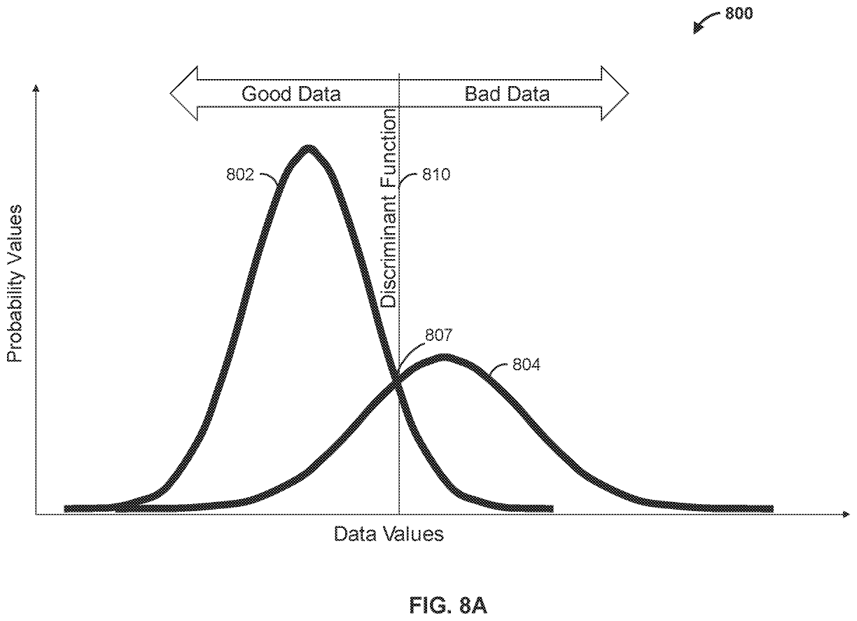

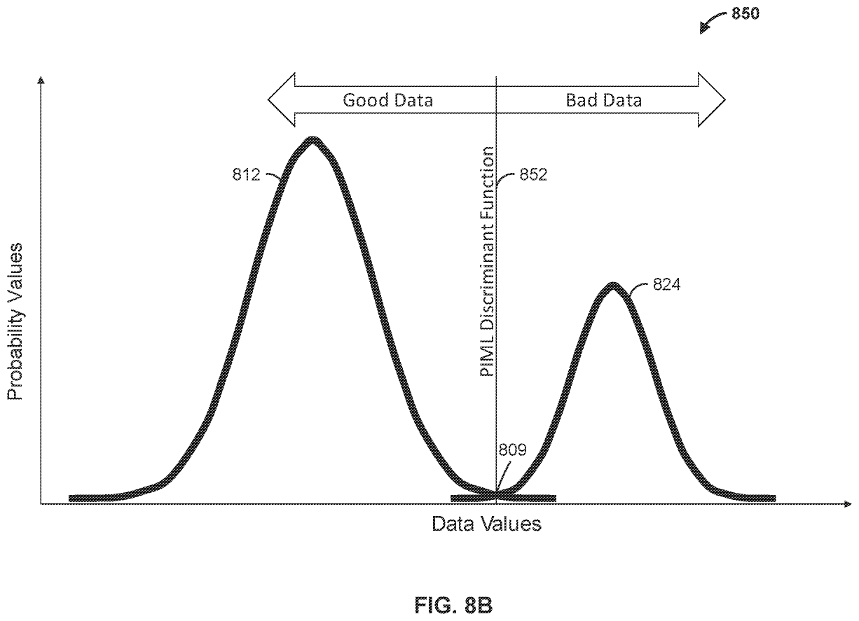

For example, FIG. 8A illustrates a probability distribution graph 800 that plots data values, such as data values received from a sensor, along a horizontal axis (e.g., “X” axis) and a probability of the data values along the vertical axis (e.g., “Y” axis). In this example, Probability distribution graph 800 includes a first curve 802 that may identify sensor data generated by a sensor, such as sensor data 303 generated by sensor 107. First curve 802 represents valid data (e.g., “Good Data”) received from the sensor. Probability distribution graph 800 further illustrates a second curve 804 that may also identify sensor data from a sensor, such as sensor data 303 generated by sensor 107. Second curve 804, however, represents invalid data (e.g., “Bad Data”) received from the sensor. First curve 802 intersects with second curve 804 at intersection point 807. Without prior knowledge of which data is valid or invalid, a conventional statistical classifier may assume that the populations are bimodal, such that first curve 802 and second curve 804 each have their own statistical distribution. As an example, a statistical classifier may differentiate between valid data and invalid data based on a discriminant function represented by the vertical line 810, which meets with first curve 802 and second curve 804 at intersection 807. In this example, the statistical classifier may determine that data to the left of the vertical line 810 is valid, and may further determine that data to the right of the vertical line 810 is invalid. Note that in the figure, the statistical classifier generates error in that a portion of data values that are invalid (as represented by second curve 804) may be classified as valid. Further, the conventional statistical classifier generates error in that a portion of data values that are valid (as represented by first curve 802) may be classified as invalid.

FIG. 8B illustrates a probability distribution graph 850 that also plots sensor data values along a horizontal axis and confidence probability of the data values along the vertical axis. In this example, probability distribution graph 850 includes a first curve 812 that may identify sensor data generated by a sensor, such as sensor data 303 generated by sensor 107. First curve 812 represents valid data (e.g., “Good Data”) received from the sensor. Probability distribution graph 850 further illustrates a second curve 824 that may also identify sensor data from a sensor, such as sensor data 303 generated by sensor 107. Second curve 824, however, represents invalid data (e.g., “Bad Data”) received from the sensor. First curve 812 intersects with second curve 824 at intersection point 809. In this example, the data plotted by first curve 812 and second curve 824 is classified by data classifier 304 (or, in some examples, error determination engine 630 described below). As illustrated, the classified data represented by first curve 812 and second curve 824 is more separated from each other, thereby reducing a classifier's error. The vertical line 852, which intersects with first curve 812 and second curve 824 at intersection point 809, represents a physics-informed machine learning (PIML) discriminant function 852.

Referring back to FIG. 3B, in some examples, input variables (e.g., sensor data 303) or functions that have low contribution to the prediction value's accuracy (e.g., as measured by a capacity or correlation to predict sensor data that is not used for the optimization of weights) may be determined and removed from the data classifier 304. As such, the computational requirements of data classifier 304 may be reduced, as well as the amount of data needed by data classifier 304 to predict values. In some examples, a reduction (e.g., an optimization) of input variables may be determined based on a Genetic Culling Algorithm.

In some examples, data classifier 304 can also be used to classify data based on evaluating a time-series form of the error, or error function, E=f(t). For example, while E may fluctuate in time, the form of these fluctuations can be used to further infer and classify the source of errors that could be causing invalid data. For example, assuming an error (e.g., as determined by an E function) that is relatively constant and/or consistently above or below a confidence interval, such a condition may indicate an offset error in a sensor 107. If instead the error fluctuates randomly with a mean that closely coincides with prediction value y_{P} 315, this may indicate noise in a sensor 107 signal. Other insights may be determined based on the error, such as potential upcoming machine failures, operational anomalies, and manufacturing defects or variations, among other things.

Fatigue failure is sudden and in cases catastrophic to a machine. In some examples prediction value y_{P} 315 may predict stress or strain magnitude suffered by a machine or system part (e.g., component). The stress or strain can be further evaluated to determine the magnitude of damage that a stress-strain event had on a part's fatigue life. Through rainflow counting, the accumulated damage of all prior stress-strain events can be used to predict a potential fatigue failure of the part. In some examples, through the combination of one or more physics-based models (e.g., physics-based model 117) associated with fatigue failure prediction and machine learning models (e.g., machine learning model 119), fatigue damage accumulation and remaining useful life of a part can be determined.

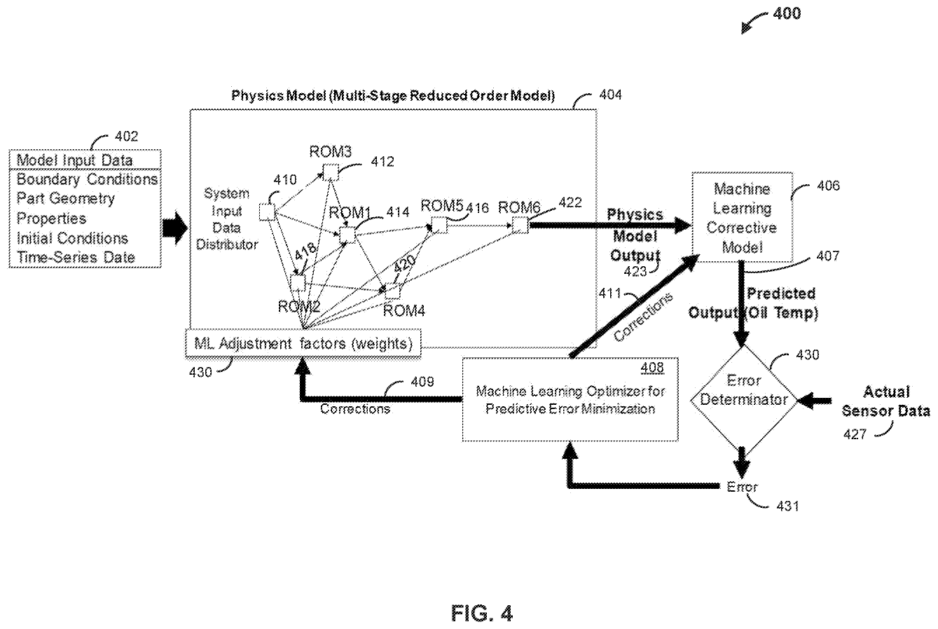

FIG. 4 illustrates a system data classification model 400 that includes a physics-based model 404 and a machine learning corrective model 406. In some examples, one or more physics functions P are based on the physics-based model 404. In this example, physics-based model 404 includes multiple ROMs 412, 414, 416, 418, 420, 422 (e.g., sub-functions) that integrate with each other, where some ROMs rely on the output of other ROMs to determine their own output. Each ROM 412, 414, 416, 418, 420, 422 may represent a mathematical or physics-based relationship between ROM inputs and ROM outputs, for example.

Physics-based model 404 also includes system input data distributor 410, which obtains model input data 402. Model input data 402 may include predetermined data stored in a database, such as database 116. Model input data 402 may include, for example, boundary condition data, part geometry data, property data, and initial condition data, which may be preconfigured and stored in database 116. Model input data 402 may also include time-series data. Time-series data may be obtained from one or more sensors 107, and may be stored in database 116 as it's received, for example, by system data classification computing device 102 from the one or more sensors 107. System input data distributor 410 can distribute at least a portion of model input data 402 to one or more of each ROM 412, 414, 416, 418, 420, 422.

In this example, system input data distributor 410 provides at least a part of model input data 402 to the first ROM 414, the second ROM 418, and the third ROM 413. The model input data 402 provided to each ROM 414, 418, 413 may be the same, or may differ, depending on the requirements of each ROM 414, 418, 413. Moreover, first ROM 414 requires the output of third ROM 412, and the output of second ROM 418. Similarly, fourth ROM 420 requires the output of first ROM 414 and the output of second ROM 418. Fifth ROM 416 requires the output of first ROM 414 and the output of fourth ROM 420. Finally, sixth ROM 422 requires the output of fifth ROM 416, and provides the output of the overall physics-based function P, identified as physics model output 423.

As an example, a physics-based function P (e.g., based on a plurality of ROMs) may solve for a transient oil temperature of an engine, and may require, as input data, time-series data of prior sensor oil temperature readings, data identifying an engine's fuel consumption, data identifying the engine's coolant temperature, data identifying the mass flow rate of the oil in the engine, data identifying the mass flow rate of the coolant in the engine, and data identifying the speed of the engine's radiator fan. These inputs may be mathematically represented as \tilde{x}ₚ It is known that oil temperature changes based on an amount of heat that is transferred from the engine's operation to the engine's oil flow. Thus, a physics-based function P may be composed of coupled sub-functions (e.g., ROMs) that determine a heat balance calculation for the engine and for the oil flow loop in the engine. The output of the physics-based function P (e.g., physics model output 423) may be a “proxy” oil temperature. That is, the proxy oil temperature may follow the general direction of the actual oil temperature, but may lack the precision necessary to predict the oil temperature that will be measured with the sensor.

To improve the accuracy of the prediction, a machine learning corrective function may obtain the “proxy” oil temperature from the physics-based function and adjust the oil temperature (e.g., makes corrections) based on design and operational considerations (e.g., variables). The structure of the machine learning corrective function can be any empirical fit function such as a neural network, a radial basis function, a multivariate linear formula, a polynomial, a Bayesian fit function (also known as Kriging), a Kohonen network, any machine learning based process or technique, or any other form of empirical fit function that is known in the art.

Referring back to FIG. 4, machine learning corrective model 406 obtains physics model output 423 from physics-based model 404, and applies one or more machine learning processes (e.g., algorithms). For example, machine learning corrective model 406 may apply a machine learning process based on Naïve Bayes, Decision Trees, Logistic Regression, K-Nearest Neighbor, Deep Learning, or Support Vector Machines. Based on application of the machine learning processes, machine learning corrective model 406 generates a predicted output 407 which, in this example, may be a predicted oil temperature.

In some examples, error determinator 430 obtains the predicted output 407 from machine learning corrective model 406, as well as actual sensor data 427 which, in this example, can be actual oil temperature data from, for example, one or more oil temperature sensors. Error determinator 430 may determine an error 431 based on predicted output 407 and actual sensor data 427. For example, error determinator 430 may determine error 431 based on an error function as described above (e.g., error function F).

In some examples, a machine learning optimizer 408 determines corrections (e.g., weights) to apply to the physics-based model 404 and/or machine learning corrective model 406 to reduce errors. For example, physics-based model 404 may include one or more adjustment factors 430 (e.g., weights) that are provided to and applied by one or more of system input data distributor 410 and ROMs 412, 414, 416, 418, 420, 422. As an example, system input data distributor 410 may apply an adjustment factor 430 to model input data 402. Similarly, a ROM, such as ROM 403, may apply an adjustment factor 430 to one or more inputs, one or more outputs, or may employ the weight (e.g., as part of one or more algorithms) to determine one or more outputs. Machine learning optimizer 408 may employ one or more machine learning processes to adjust one or more of the adjustment factors 430 based on error 431. For example, machine learning optimizer 408 may generate corrections 409 that identify and characterize an adjustment to one or more of the adjustment factors 430, and provide the corrections 409 to physics-based model 404. Similarly, machine learning optimizer 408 may generate corrections 411 to adjust one or more weights applied by machine learning corrective model 406. As such, weights for each of physics-based model 404 and machine learning corrective model 406 may be updated during operation (e.g., in real-time) to reduce, for example, predicted output 407 errors.

In some instances, there may be a need to quickly evaluate sensor error, such as when performing a fast sampling of sensor data. For example, there may be a need to classify sensor data in real-time or, in some examples, faster than real-time. Referring back to FIG. 4, the evaluation of each individual ROM every time a new data point is generated (e.g., model input data 402 changes) may increase processing requirements. To alleviate these processing requirements, physics model 404 may condition the evaluation of each individual ROM based on whether the inputs to each individual ROM have changed or, in some examples, whether they have changed significantly enough to generate a change in that ROM's output or, in some examples, that affects physics model output 423 and/or the predicted output 407 (e.g., in a significant manner). Thus, for at least one of the ROMs, or for each one of the ROMs, once physics model 404 is trained, and all weight and correction values are established, the inputs for at least one of the ROMs, or for each one of the ROMs, can be varied to determine a magnitude of change in physics model output 423 and/or the predicted output 407. In some examples the degree of variation may be compared to an error distribution obtained during training. If changes in the inputs of at least one of the ROMs, or for each one of the ROMs, causes a change in the physics model output 423 and/or the predicted output 407 that is within a user determined acceptable range and is within the range of the error distribution, then that ROM is not executed and the output value of the ROM that was used in a previous iteration is used. As such, this process may alleviate the processing requirements, such as computational time, of executing physics model 404.

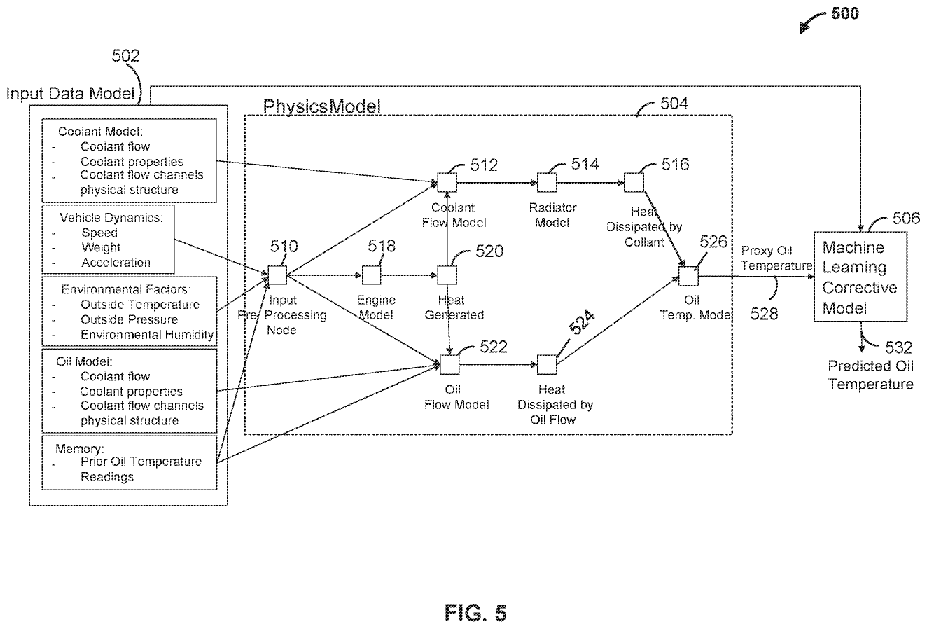

FIG. 5 illustrates a system data classification model 500 that includes physics-based model 504 and machine learning corrective model 506. Physics-based model 504 includes an input pre-processing node 510, which obtains input data 502, and can provide the input data 503 to one or more models. Input data 502 may be obtained, for example, from one or more sensors, such as sensors 107, or from a database, such as database 116 (e.g., for input data 502 that is preconfigured and does not change). In some examples, input pre-processing node 510 scales (e.g., adjusts, weights) one or more of input data 502.

Physics-based model 504 also includes a coolant flow model 512, an engine model 518, a radiator model 514, an oil flow model 522, and an oil temperature model 526. Each of the coolant flow model 512, engine model 518, radiator model 514, oil flow model 522, and oil temperature model 526 may be a ROM, or SM, for example. In this example, engine model 518 obtains input data from input pre-processing node 510 and determines a heat generated 520 (e.g., an amount of heat generated by an engine being simulated). Coolant flow model 512 obtains input data from input pre-processing node 510, as well as heat generated 520 and coolant model specific data from input data 502 (e.g., coolant properties, coolant flow channels physical structure), and provides output data to radiator model 514. Radiator model 514 determines a heat dissipated by coolant 516 based on the output data provided by coolant flow model 512.

Oil flow model 522 obtains input data from input pre-processing node 510, as well as heat generated 520 and oil flow model specific data from input data 502 (e.g., prior oil temperature readings), and generates heat dissipated by oil flow 524. Oil temperature model 526 obtains heat dissipated by coolant 516 from radiator model 514 as well as heat dissipated by oil flow 524 from oil flow model 522, and generates proxy oil temperature 528.

Machine learning corrective model 506 obtains proxy oil temperature 528, and determines a predicted oil temperature 532 based on applying one or more machine learning processes to the proxy oil temperature 528 and one or more of input data 502. For example, machine learning corrective model 506 may apply a machine learning algorithm based on Naïve Bayes, Decision Trees, Logistic Regression, K-Nearest Neighbor, Deep Learning, or Support Vector Machines. Predicted oil temperature 532 may, in some examples, be compared to sensor data received from an oil temperature sensor to determine if the sensor is providing valid data.

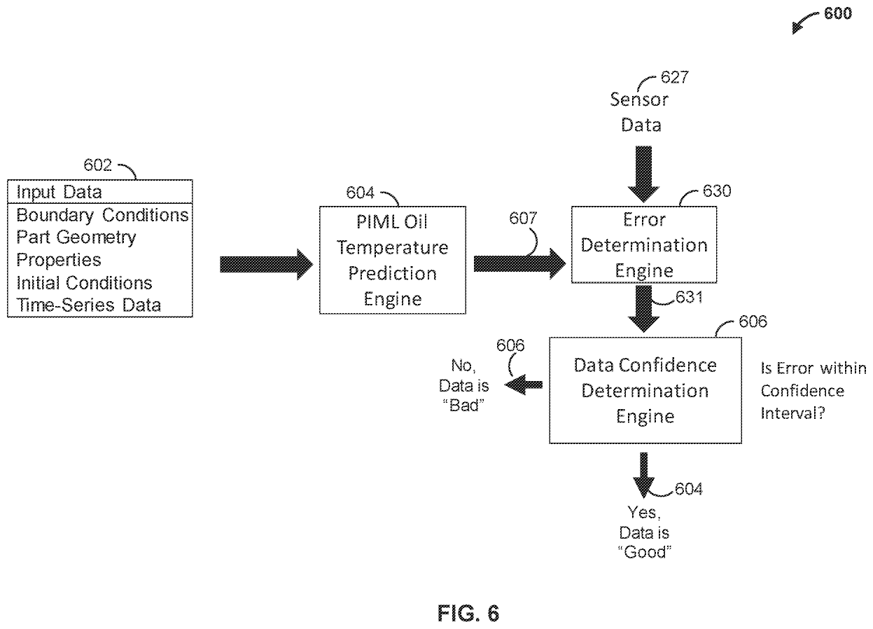

FIG. 6 an oil temperature prediction system 600 that includes oil temperature prediction engine 604, error determination engine 430, and data confidence determination engine 616. All or part of each of oil temperature prediction engine 604, error determination engine 430, and data confidence determination engine 616 may, in some examples, be implemented in hardware. All or party of each of oil temperature prediction engine 604, error determination engine 430, and data confidence determination engine 616 may, in some examples, be implemented as executable instructions (e.g., stored in instruction memory 207) executed by one or more processors, such as processor(s) 201.

Oil temperature prediction engine 604 may include a physics-based model, such as physics-based model 404, and a machine learning model, such as machine learning corrective model 406. Oil temperature prediction engine 604 may receive input data 602, and, based on execution of the physics-based model and machine learning model, generate a predicted output 607. Predicted output 607 may be, for example, a predicted oil temperature.

Error determination engine 630 obtains predicted output 607 from oil temperature prediction engine 604, and sensor data 627. Sensor data 627 may identify data related to sensor readings of a system, such as oil temperature data from an oil sensor. Error determination engine 630 may determine an error 631 based on predicted output 607 and sensor data 627. For example, error determination engine 630 may execute an error function (e.g., such as error function E described above) to identify a relative or actual difference between predicted output 607 and sensor data 627. Error determination engine 630 generates

Data confidence determination engine 616 is operable to classify predicted output 607 as good data 604 or bad data 606 based on error 631. For example, data confidence determination engine 616 may determine whether error 631 is within a confidence interval (e.g., a predetermined range). If error 631 is within the confidence interval, sensor data 627 is classified as good data 604. Otherwise, if error 631 is not within the confidence interval, sensor data 627 is classified as bad data 606. In some examples, the determination of whether sensor data 627 is good or bad is displayed on a display, such as display 206. In some examples, a communication is generated and transmitted indicating the determination. For example, the communication may be an email, or a short message service (SMS) message (e.g., text message). The communication may be transmitted to, for example, an operator of the system affected. In some examples, only indications of “bad data” are transmitted.

While above embodiments illustrate examples in which a data classifier (e.g., data classifier 304), such as one employed by system data classification computing device 102, employs a physics-based model and a machine learning model to determine a quality of data received from sensors, the data classifier can also be used to classify device operating regimes. An operating regime may be a particular device usage method, such as a method in which different users may operate the device, different states of operation of the device, distinguishable control regimes, or any other operating regimes. For example, an electric vehicle air conditioning system may have multiple operating regimes that include cabin cooling only using outdoor air, cabin cooling only using the vehicle's vapor compression system, cabin cooling using the vehicle's vapor compression system, or vehicle battery cooling using the vehicle's vapor compression system, among others. Each one of these regimes could result in distinctly different types of data generation from the same set of sensors.

Through the application of a physics-based model and a machine learning model as described herein, a data classifier can classify the data as either belonging to a particular operating regime (e.g., expected operating regime), or not belonging to the particular operating regime. As with the embodiments described above that classify data as valid or invalid, the device may evaluate an error between a predicted output (as generated by the device based on the physics-based model and the machine learning model) and actual sensor data. However, in this case, the physics-based model is designed to capture the unique physics of an operating regime that is being evaluated. In some examples, the data classifier is trained only using data associated with the operating regime that is being evaluated. In some examples, an error confidence interval may be determined during training. The data classifier can then evaluate an error between the predicted sensor reading and the actual sensor reading. If the error is within the confidence interval, the data classifier may determine that the data was generated by a sensor that is measuring a device's performance correctly under the operating regime that the data classifier is evaluating. If, however, the error falls outside of the confidence interval, then the data classifier determines that the sensor is measuring a device's performance that does not correspond to the operating regime that the data classifier is evaluating.

In this manner, multiple classifiers forming a System of Operating Regime Classifiers may be employed to determine which potential operating regimes data, such as sensor data, belongs to. If two or more classifiers in the system determine that the data belongs to different operating regimes, a final determination of operating regime may be made by evaluating the magnitude of the error generated by the classifiers. In some examples, the range of confidence intervals of each classifier can be individually optimized through machine learning techniques to improve accuracy of the system.

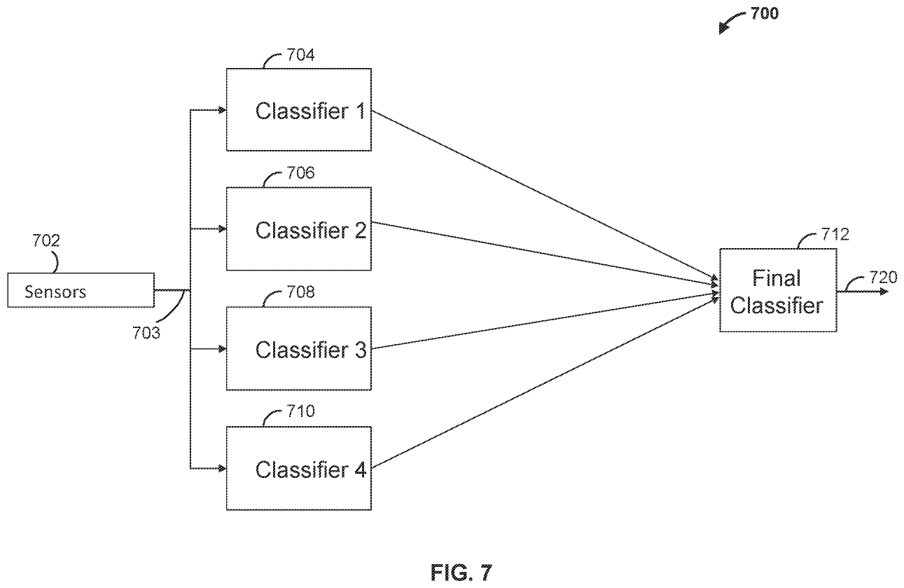

For example, FIG. 7 illustrates a multi-level classification scheme 700 that may be employed by the system data classification computing device of FIG. 2. In this example, sensors 702 from a system provide sensor data 703 to a plurality of classifiers 704, 706, 708, 710. The sensor data 703 received by each of the classifiers 704, 706, 708, 710 may be the same sensors 702 (e.g., the same sensor data 703), or different sensors 702.

In this example, each classifier 704, 706, 708, 710 generates output data indicating whether the system is operating in accordance with a particular operating regime. For example, first classifier 704 may generate output data indicating whether the system is operating under a first operating regime. Similarly, second classifier 706 may generate output data indicating whether the system is operating under a second operating regime; third classifier 708 may generate output data indicating whether the system is operating under a third operating regime; and fourth classifier 710 may generate output data indicating whether the system is operating under a fourth operating regime. In some examples, each classifier 704, 706, 708, 710 generates a confidence value (e.g., confidence score) indicating a confidence (e.g., probability) that the system is operating under the corresponding operating regime.

The output data generate by each classifier 704, 706, 708, 710 is provided to a final classifier 712, which generates output data 720 indicating an operating regime the system is operating in. As an example, assume that first classifier 704 generates output data indicating that the system is operating under a first operating regime. In addition, assume that second classifier 706 generates output data indicating that the system is not operating under a second operating regime, third classifier 708 generates output data indicating that the system is not operating under a third operating regime, and fourth classifier 710 generates output data indicating that the system is not operating under a fourth operating regime. In this example, final classifier 712 may generate output data 720 indicating that the system is operating under the first operating regime.

As another example, assume that first classifier 704 generates output data indicating that the system is operating under a first operating regime, with a confidence value of 52%. In addition, assume that second classifier 706 generates output data indicating that the system is operating under a second operating regime with a confidence value of 73%. Further assume that third classifier 708 generates output data indicating that the system is operating under a third operating regime with a confidence value of 12%, and that fourth classifier 710 generates output data indicating that the system is operating under a fourth operating regime with a confidence value of 7%. In this example, final classifier 712 may generate output data 720 indicating that the system is operating under the second operating regime. These are merely examples, and final classifier 712 may generate output data 720 based on one or more machine learning processes employed by final classifier 712.

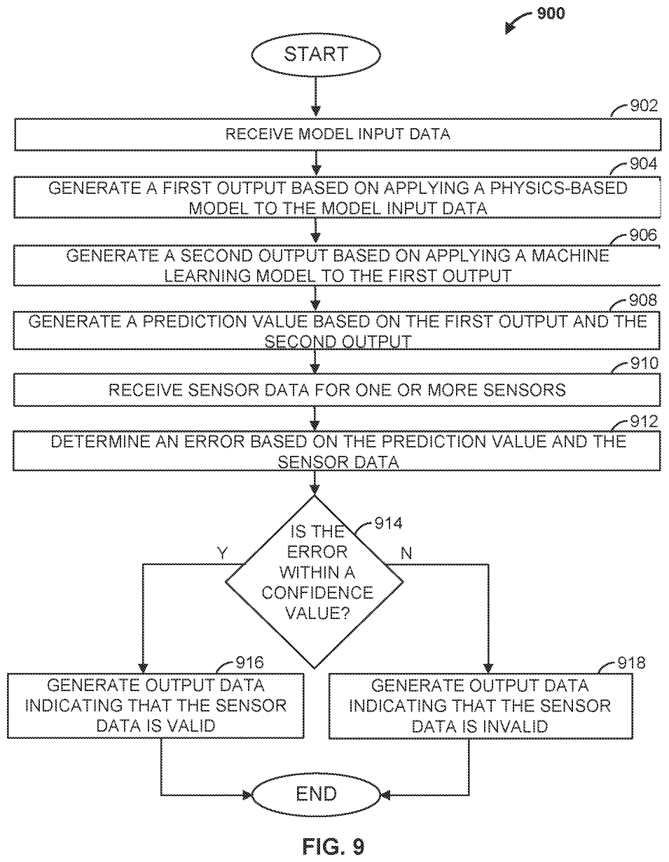

FIG. 9 is a flowchart of an example method 900 that can be carried out by the surrogate model computing system 100 of FIG. 1. Beginning at step 902, model input data is received. The model input data may include, for example, one or more of boundary conditions, part geometry, properties, initial conditions, and time-series data, such as previous sensor data readings over a period of time. At step 904, a first output is generated based on applying a physics-based model to the model input data. For example, surrogate model computing device 102 may apply physics-based mode 404 to model input data 402 to generate physics model output 423.

Proceeding to step 906, a second output is generated based on applying a machine learning model to the first output. For example, surrogate model computing device 102 may apply machine learning corrective model 406 to physics model output 423 to generate the second output. At step 908, a prediction value is generated based on the first output and the second output. The prediction value (e.g., prediction value yₚ) may be a prediction value for sensor data, and may be based on equation 1 above, for example.

At step 910, sensor data for one or more sensors of the system is received. For example, the sensor data may indicate an oil temperature. At step 912, an error is determined based on the prediction value and the sensor data. For example, the error may be determined based on an error function, such as an error function E as described above.

At step 914, a determination is made as to whether the determined error is within a confidence interval. If the error is within the confidence interval, the method proceeds to step 916, where output data is generated indicating that the sensor data is valid. The method then ends. Otherwise, if at step 914, the error is not within the confidence interval, the method proceeds to step 918, where output data is generated indicating that the sensor data is not valid. The method then ends.

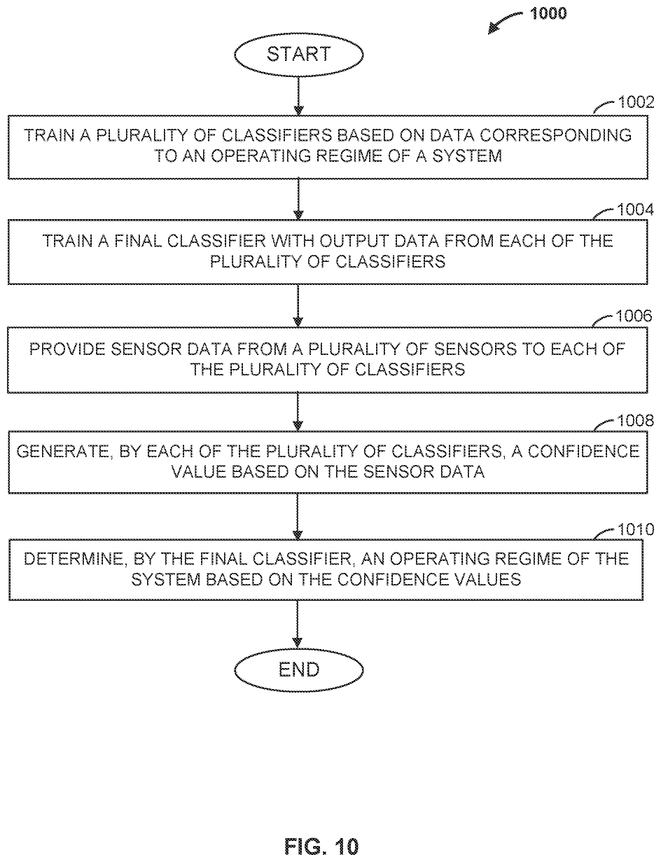

FIG. 10 is a flowchart of another example method 1000 that can be carried out by the system data classification system 100 of FIG. 1. Beginning at step 1002, each of a plurality of classifiers are trained based on data corresponding to an operating regime of a system. For example, each classifier may be trained with data associated with a different operating regime of the system. At step 1004, a final classifier is trained with output data from each of the plurality of classifiers.

Proceeding to step 1006, sensor data from a plurality of sensors is provided to each of the plurality of classifiers receives. For example, the classifiers may receive sensor data from the same sensors, or different sensors. At step 1008, each of the plurality of classifiers generates a confidence value based on the sensor data. Each confidence value indicates a likelihood (e.g., probability) that the system is operating in the operating regime corresponding to each classifier. At step 1010, the final classifier determines AN operating regime of the system based on the confidence values. The method then ends.

As a further example of a different embodiment, for the purpose of cleaning and classifying time-series data obtained in the test of engine oil temperature (e.g., received with model input data 402), a classifier system (e.g., data classifier 304) with an initial data pre-processing step may be employed. In the initial pre-processing step (e.g., as performed by an initial pre-processing engine), a series of tests may be performed to determine data sufficiency, to assure “rules of thumb” are satisfied, and to identify erroneous (e.g., obviously impossible) readings from sensors. The series of tests may be performed as a first-pass filter to identify invalid data 320. The pre-processed data (e.g., pre-processed time-series data) may then be sent to the data classifier 304 for further classification. The data classifier 304 may include a physics-based model 117 that, in this example, is a physics informed surrogate model 310 that can predict the engine oil temperature given the time-series data of prior sensor oil temperature readings, data identifying engine's fuel consumption, data identifying mass flow rate of the engine oil, data identifying the engine speed, and time-series data of sensor ambient temperature readings. These inputs may be mathematically represented as \tilde{x}ₚ.

A physics informed surrogate model may be represented as a physics-based function P (e.g., physics model 404) of the aforementioned inputs which determines a transient heat balance calculation for the engine and for the oil flow loop in the engine. The output of the physics-based function P (e.g., physics model output 423) may be a “proxy” oil temperature. That is, the proxy oil temperature may follow the general direction of the actual oil temperature but may lack the precision necessary to predict the oil temperature that may be measured with a sensor. The transient heat balance equation that would be determined may be given by:

$$\frac{{dT}_{oil pred}}{dt} = \frac{1}{{m}_{oil} {C}_{v}} [ α ( t ) * Qloss ( engine ) - {\dot{m}}_{oil} {C}_{p} \cdot ( {T}_{oil pred} - {T}_{ambient} ) ] \qquad ( eq . 2 )$$

where:
   dt is the time increment;
   dT_{oil pred} is the change in engine oil temperature;
   mₒᵢₗ is the mass flow rate of engine oil;
   Cₚ and Cᵥ are specific heat by pressure and volume of engine oil;
   Qloss (engine) is the heat loss from engine;
   α(t) is the function that determines the percentage of the engine heat loss transferred to engine oil;
   T_{ambient} is the ambient temperature.

The above transient heat balance equation provides a “proxy” change in engine oil temperature that is determined from the heat added to the engine oil by the engine and the heat lost to the ambient environment from engine oil. However, the percentage of heat loss from the engine that is transferred to the engine oil (α(t)*Qloss(engine)), mass flow rate of the engine oil (\dot{m}ₒᵢₗ)) and specific heat (Cᵥ) may be unknowns. They can be assumed, in some examples, to vary as a function of engine speed with associated model parameters (C0, C1, C2, C3) as shown in the equation below:

$$\frac{{dT}_{oil pred}}{dt} = [ ( C 0 \cdot e - t + C 1 ) \cdot EngineSpeed + ( C 2 \cdot EngineSpeed + C 3 ) \cdot ( 0.0037 \cdot {T}_{oil pred i - 1} + 1.8161 ) \cdot ( {T}_{oil pred i - 1} - {T}_{ambient} ) ] \qquad ( eq . 3 )$$

These model parameters may then be fit for every individual time series data of sensor oil temperature readings such that the error function E between the predicted engine oil temperature, given by prediction value yₚ 315, and the actual engine oil temperature readings, given by y, is minimized. The error function E may be determined based on, for example, a squared difference between yₚ 315 and y, a mean square error, an absolute value of the difference between yₚ and y, or any other suitable error functions known in the art. The predicted value yₚ 315 may then be passed to data evaluator 314 along with sensor data 303 of the engine oil temperature. Data evaluator engine 314 may then compare the prediction value yₚ 315 to the sensor data 303 to generate error metrics such as the R² value and the root mean square error (RMSE).

The R² value metric indicates the measure of noise in the engine oil temperature data, and the RMSE value indicates the “goodness of fit” of the predicted engine oil temperature to the actual engine oil temperature sensor readings. If the error value is within a confidence interval (e.g., a range of values), data evaluator engine 314 may classify the sensor data 303 as valid data 322 (e.g., good data). Otherwise, if the error value is not within the confidence interval, data evaluator engine 314 may classify the sensor data 303 as invalid data 320 (e.g., bad data). In some examples, the confidence interval is predetermined. For example, the confidence interval may be provided by a user to 102, and stored in database 116. In some examples, the confidence interval is empirically determined. In some examples, valid data 322 and invalid data 320 are binary values (e.g., “0” for invalid sensor data, “1” for valid sensor data).

In some examples, the actual values of R² and RMSE that determine the classification of oil temperature as good or bad data can be determined through evaluation of the RMSE values and R² values of data previously classified as “good” or “bad” by the user, so that the classification error is minimized. One method includes applying the Bayes-Naïve theory of classification, where (e.g., optimum) RMSE and R² values are determined independent of each other by determining the probability distribution function of these values for user determined “good” and “bad” data. The optimum classifier may be the RMSE and the R² values where the probability distribution function of the “good” data and the “bad” data are equal, or near equal, to each other. Other optimization methods can be also be applied, such as Decision Trees, Logistic Regression, K-Nearest Neighbor, Deep Learning, Support Vector Machines, or any other machine learning model or algorithm known in the art, such as one that is based on an initial training set consisting of valid and invalid data and corresponding error values, where the data has been appropriately determined to be valid or invalid (e.g., predetermined by a user).

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A computing device configured to:
receive sensor data from at least one sensor for a system;
determine a first value based on execution of a first model that operates on the sensor data and characterizes a relationship between inputs to the system and outputs from the system;
determine a second value based on execution of a second model that operates on the first value;
determine a sensor prediction value for the at least one sensor based on the first value and the second value; and
determine whether the sensor data is valid based on the sensor prediction value.

2. The computing device of claim 1, wherein the first model is a physics-based model that operates on the sensor data and is based on at least one mathematical relationship between inputs to the system and outputs from the system, and the second model is a machine learning model that operates on the first value.

3. The computing device of claim 2, wherein the physics-based model comprises a first weight and the machine learning model comprises a second weight, wherein the computing device is configured to train the first weight and the second weight based on the sensor prediction value and the sensor data.

4. The computing device of claim 2, wherein the computing device is further configured to receive model input data, and wherein the physics-based model operates on the model input data.

5. The computing device of claim 4, wherein the model input data comprises time-series data of prior sensor oil temperature readings of an engine, data identifying the engine's fuel consumption, data identifying the engine's coolant temperature, data identifying the mass flow rate of the oil in the engine, data identifying the mass flow rate of the coolant in the engine, and data identifying the speed of the engine's radiator fan.

6. The computing device of claim 1, wherein the at least one sensor comprises a first sensor and a second sensor, the first model is a first classifier that operates on first sensor data from the first sensor, and the second model is a final classifier, the computing device further configured to:
determine a third value based on execution of a second classifier that operates on second sensor data from the second sensor; and
determine the second value based on execution of the final classifier that operates on the first value and the third value.

7. The computing device of claim 6, wherein the computing device is further configured to:
train the first classifier with first system data corresponding to a first operating regime of the system;
train the second classifier with second system data corresponding to a second operating regime of the system;
apply the trained first classifier to the first sensor data to generate first output data;
apply the trained second classifier to the second sensor data to generate second output data; and
train the final classifier with the first output data and the second output data.

8. The computing device of claim 1, wherein determining whether the sensor data is valid comprises:
determining whether the sensor prediction value is within a confidence interval;
determining that the sensor data is valid when the sensor prediction value is within the confidence interval; and
determining that the sensor data is invalid when the sensor prediction value is not within the confidence interval.

9. The computing device of claim 1, wherein the computing device is further configured to:
receive current sensor data for the at least one sensor;
determine an error value based on the sensor prediction value and the current sensor data; and
determine at least one adjustment to a weight applied by the first model based on the error value.

10. The computing device of claim 1, wherein the sensor data comprises an oil temperature of an engine.

11. The computing device of claim 1, wherein the sensor prediction value is a predicted temperature and the sensor data is an actual temperature.

12. A method comprising:
receiving sensor data from at least one sensor for a system;
determining a first value based on execution of a first model that operates on the sensor data and characterizes a relationship between inputs to the system and outputs from the system;
determining a second value based on execution of a second model that operates on the first output;
determining a sensor prediction value for the at least one sensor based on the first value and the second value; and
determining whether the sensor data is valid based on the sensor prediction value.

13. The method of claim 12, wherein the first model is a physics-based model that operates on the sensor data and is based on at least one mathematical relationship between inputs to the system and outputs from the system, and the second model is a machine learning model that operates on the first value.

14. The method of claim 13, wherein the physics-based model comprises a first weight and the machine learning model comprises a second weight, wherein the method comprises training the first weight and the second weight based on the sensor prediction value and the sensor data.

15. The method of claim 13, comprising receiving model input data, and wherein the physics-based model operates on the model input data.

16. The method of claim 14, wherein the model input data comprises time-series data of prior sensor oil temperature readings of an engine, data identifying the engine's fuel consumption, data identifying the engine's coolant temperature, data identifying the mass flow rate of the oil in the engine, data identifying the mass flow rate of the coolant in the engine, and data identifying the speed of the engine's radiator fan.

17. The method of claim 12, wherein the at least one sensor comprises a first sensor and a second sensor, the first model is a first classifier that operates on first sensor data from the first sensor, and the second model is a final classifier, the method comprising:
determining a third value based on execution of a second classifier that operates on second sensor data from the second sensor; and
determining the second value based on execution of the final classifier that operates on the first value and the third value.

18. A non-transitory computer readable medium having instructions stored thereon, wherein the instructions, when executed by at least one processor, cause a device to perform operations comprising:
receiving sensor data from at least one sensor for a system;
determining a first value based on execution of a first model that operates on the sensor data and characterizes a relationship between inputs to the system and outputs from the system;
determining a second value based on execution of a second model that operates on the first output;
determining a sensor prediction value for the at least one sensor based on the first value and the second value; and
determining whether the sensor data is valid based on the sensor prediction value.

19. The non-transitory computer readable medium of claim 18 wherein the first model is a physics-based model that operates on the sensor data and is based on at least one mathematical relationship between inputs to the system and outputs from the system, and the second model is a machine learning model that operates on the first value.

20. The non-transitory computer readable medium of claim 15, wherein the at least one sensor comprises a first sensor and a second sensor, the first model is a first classifier that operates on first sensor data from the first sensor, and the second model is a final classifier, and further comprising instructions stored thereon that, when executed by at least one processor, further cause the device to perform operations comprising:
determining a third value based on execution of a second classifier that operates on second sensor data from the second sensor; and
determining the second value based on execution of the final classifier that operates on the first value and the third value.
